(19) United States
(12) Patent Application Publication
(10) Pub. No.: US 2005/0177979 A1
(43) Pub. Date: Aug. 18, 2005

(54) Hinge assembly for foldable electronic device

(75) Inventors: Chao Duan, Shenzhen (CN); Rui-Hao Chen, Shenzhen (CN); Jiang-Yuan He, Shenzhen (CN); Chia-Hua Chen, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/021,925

(22) Filed: Dec. 23, 2004

(30) Foreign Application Priority Data
Feb. 17, 2004 (TW) 93202230

(51) Int. Cl. E05D 11/08

(52) U.S. Cl. 16/337

(57) ABSTRACT

A hinge assembly includes a body drive member (1) having an outer screw thread (16), a cover drive member (2) having a projection (26) on an outer periphery, and a locating member (3). The cover drive member defines a central hole (23) and an inner screw thread (25) therein. The locating member has a base board (31), and a hatch (32) defined therein. Two arms (33) extend from opposite edges of the base board, and a bent portion (34) is formed at a distal end of each arm. The body drive member extends through the hatch and the hole, thereby integrating the hinge assembly into a complete unit, with the outer screw threadingly engaging with the inner screw thread, and the projection abutting the bent portion. The hinge assembly exerts reduced force on a foldable electronic device when the foldable electronic device is opened or closed.

### CROSS-REFERENCE TO RELATED APPLICATIONS

This application is related to U.S. patent application Ser. No. 10/904,797, entitled “HINGE ASSEMBLY FOR FOLDABLE ELECTRONIC DEVICE”, filed on Nov. 30, 2004 with the same assignee as the instant application. The disclosure of the above identified application is incorporated herein by reference.

### BACKGROUND OF THE INVENTION

1. Field of the Invention

The present invention relates to hinge assemblies, and particularly to a hinge assembly for foldable electronic devices such as mobile telephones, electronic notebooks, and so on.

2. Description of Prior Art

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body. The other housing, called the cover, normally contains fewer electronic components than the body. Other foldable electronic devices have all the electronics in the body, with the cover containing no electronics. Various types of hinge assemblies are used to join a body and a cover of a foldable electronic device, so that the cover can unfold up from and fold down upon the body.

U.S. Pat. No. 6,175,990 issued on Jan. 23, 2001 provides a hinge assembly used in a small-size foldable electronic device such as a portable telephone, a portable computer, an electronic notebook or the like. As represented in FIG. 8, the hinge assembly includes a shaft 10 provided with a discoid head 102 at a first end portion thereof, a fixing member 20, a fixed cam 30, a rotary sliding cam 40, and a compression spring 50. An opposite second end portion of the shaft 10 is extended through the fixed cam 30, the rotary sliding cam 40, the compression spring 50 and the fixing member 20 in that order, thereby integrating the hinge assembly into a complete unit.

The fixed cam 30 abuts the head 102 of the shaft 10, and is rotatable relative to the shaft 10. A pair of opposite recessed cam portions 302 is defined on an end of the fixed cam 30. A pair of opposite projection portions 402 is formed on an end face of the rotary sliding cam 40, corresponding to the cam portions 302. With the engagement of the cam portions 302 and the projection portions 402, the fixed cam 30 and the rotary sliding cam 40 are axially movable relative to each other and rotatable relative to each other. The rotary sliding cam 40 is axially movable relative to the shaft 10, and rotatable with the shaft 10. The fixing member 20 is secured around the second end portion of the shaft 10. The compression spring 50 is elastically engaged around the shaft 10 between the rotary sliding cam 40 and the fixing member 20, and continually presses the rotary sliding cam 40 against the fixed cam 30.

When the projection portions 402 of the rotary sliding cam 40 are engaged with the cam portions 302 of the fixed cam 30, the foldable electronic device is in a closed position. When the foldable electronic device is opened, the projection portions 402 move out from engagement with the cam portions 302 onto coplanar end faces of the fixed cam 30. Once the foldable electronic device is opened to an angle of about 1600, the projection portions 402 snappingly engage into the corresponding cam portions 302 and are locked therein. However, during the process of the foldable electronic device being opened, a body and a cover of the foldable electronic device are directly subjected to force produced by the fixed cam 30, the rotary sliding cam 40 and the compression spring 50. This force is liable to cause damage to the body and the cover.

In view of the above-described shortcomings, a new, safer and more durable hinge assembly is desired.

### SUMMARY OF THE INVENTION

An object of the present invention is to provide a hinge assembly which can reduce the force it exerts on a foldable electronic device when the foldable electronic device is opened or closed.

A hinge assembly according to the present invention includes a body drive member, a cover drive member, and a locating member. The body drive member has an outer screw thread. The cover drive member has a projection formed on an outer periphery thereof, and defines a central hole. An inner screw thread is formed in the hole. The locating member has a base board, and a hatch defined in the center of the base board. Two arms extend from opposite edges of the base board, and a bent portion is formed at a distal end of each arm. The body drive member extends through the hole of the cover drive member and the hatch of the locating member, thereby integrating the hinge assembly into a complete unit, with the outer screw thread of the body drive member threadingly engaging with the inner screw thread of the cover drive member, and the projection of the cover drive member abutting the bent portion of the locating member.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a hinge assembly according to a preferred embodiment of the present invention, the hinge assembly including a locating member;

FIG. 2 is similar to FIG. 1, but viewed from a reverse aspect;

FIG. 3 is an enlarged, assembled view of the hinge assembly according to the preferred embodiment of the present invention, showing the hinge assembly positioned corresponding to a closed position of a foldable electronic device;

FIG. 4 is a cross-sectional view taken along line IV-IV of FIG. 3;

FIG. 5 is similar to FIG. 3, but showing the hinge assembly positioned corresponding to an open position of the foldable electronic device;

FIG. 6 is a cross-sectional view taken along line VI-VI of FIG. 5;

FIG. 7 is an enlarged, isometric view of a locating member according to an alternative embodiment of the present invention; and

FIG. 8 is an exploded, isometric view of a conventional hinge assembly.

### DETAILED DESCRIPTION OF THE INVENTION

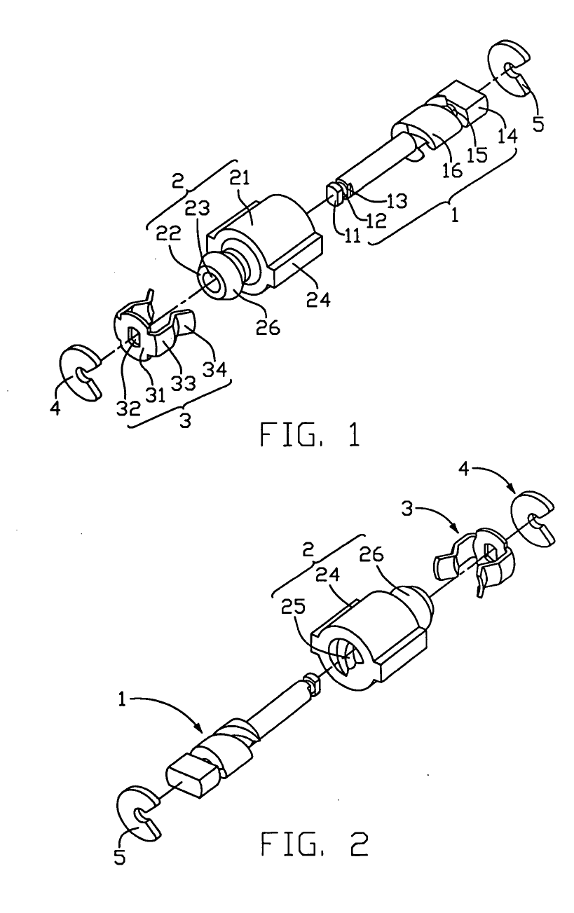

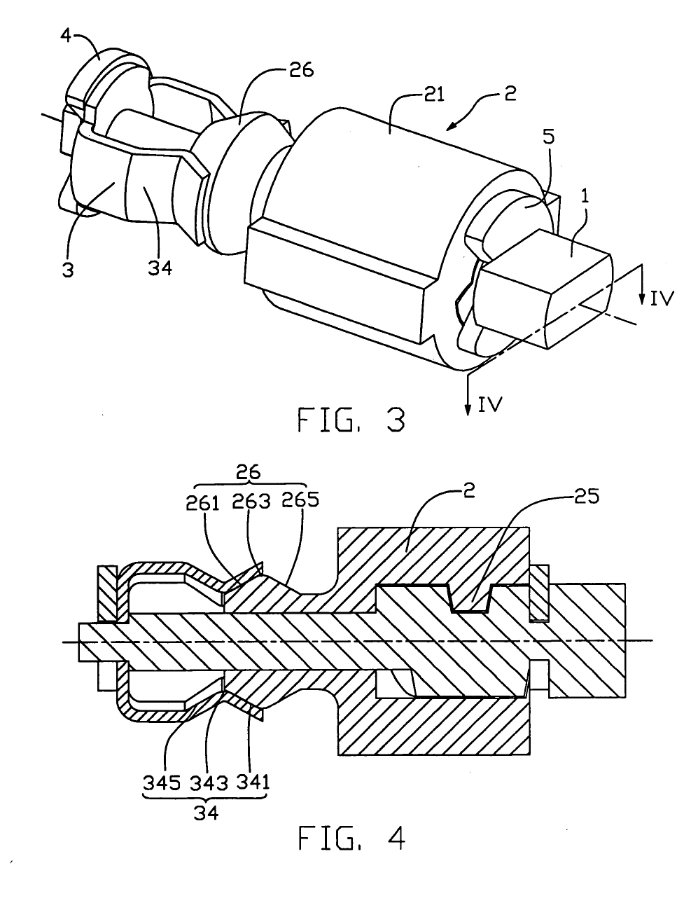

FIG. 3 shows a hinge assembly according to the preferred embodiment of the present invention, which is used to interconnect components like a body (not shown) and a cover (not shown) of a foldable electronic device. Also referring to FIGS. 1 and 2, the hinge assembly includes a body drive member 1, a cover drive member 2, a locating member 3 and two disks 4, 5. The body drive member 1 extends through the cover drive member 2, the locating member 3 and the disks 4, 5, thereby integrating the hinge assembly into a complete unit.

The body drive member 1 is a shaft essentially in the form of a round rod. A keyed head 11 is defined at a first end of the body drive member 1, and a lock member 14 is formed at an opposite second end of the body drive member 1. The lock member 14 is substantially a regular block, and is engaged with the body of the foldable electronic device so that the body drive member 1 does not rotate relative to the body. A pair of annular grooves 12, 15 is defined in the body drive member 1, adjacent the head 11 and adjacent the lock member 14 respectively. A pair of opposite slots 13 is defined in the body drive member 1 immediately adjacent the groove 12. An outer screw thread 16 is formed on an outer periphery of the body drive member 1 adjacent the groove 15.

The cover drive member 2 includes a first tubular portion 21 with a larger outer diameter, and a second tubular portion 22 with a smaller outer diameter. The two tubular portions 21, 22 are coaxial with each other, and have a common central hole 23.

A pair of protrusions 24 is provided on an outer periphery of the first tubular portion 21, the protrusions 24 being circumferentially spaced apart according to a predetermined angle. The protrusions 24 are engaged with the cover of the foldable electronic device, so that the first tubular portion 21 and hence the cover drive member 2 are rotatable in unison with the cover. An inner screw thread 25 is formed on an inside wall of the first tubular portion 21. The inner screw thread 25 is threadingly engaged with the outer screw thread 16 of the body drive member 1, so that the first tubular portion 21 and hence the cover drive member 2 can rotate relative to the body drive member 1.

The second tubular portion 22 has an annular projection 26 formed on a circumferential periphery thereof. As shown in FIG. 4, the projection 26 has two slopes 261, 265 at opposite sides of a ridge 263 respectively.

The locating member 3 is made of an elastic material, and has a base board 31. A hatch 32 is defined in a center of the base board 31. The base board 31 is engaged with the body drive member 1 in the slots 13. A pair of symmetric arcuate arms 33 extends perpendicularly from two opposite edges of the base board 31 respectively. A distal end of each arm 33 is bent radially inwardly to form a bent portion 34. As shown in FIG. 4, the bent portion 34 has two slopes 341, 345 at opposite sides of a ridge 343 respectively.

The disks 4, 5 are made of metallic material. Each of the disks 4, 5 defines a generally Y-shaped notch (not labeled) therein. This enables the disks 4, 5 to be snappingly secured on the body drive member 1 in the grooves 12, 15 respectively.

In assembly of the hinge assembly, the disk 5 is secured on the second end of the body drive member 1 in the groove 15. The first end of the body drive member 1 is rotated into the hole 23 of the cover drive member 2, with the outer screw thread 16 of the body drive member 1 engaging with the inner screw thread 25 of the first tubular portion 21 of the cover drive member 2, until the first tubular portion 21 abuts the disk 5. The first end of the body drive member 1 is inserted through the hatch 32 of the locating member 3, so that the base board 31 is engaged with the body drive member 1 in the slots 13. The disk 4 is secured on the first end of the body drive member 1 in the groove 12. The base board 31 of the locating member 3 abuts the disk 4. The bent portions 34 of the locating member 3 abut the second tubular portion 22, with the slopes 341 of the bent portions 34 of the locating member 3 slidably abutting against the slope 261 of the projection 26 of the second tubular portion 22. The hinge assembly is thus completely assembled, as shown in FIGS. 3 and 4.

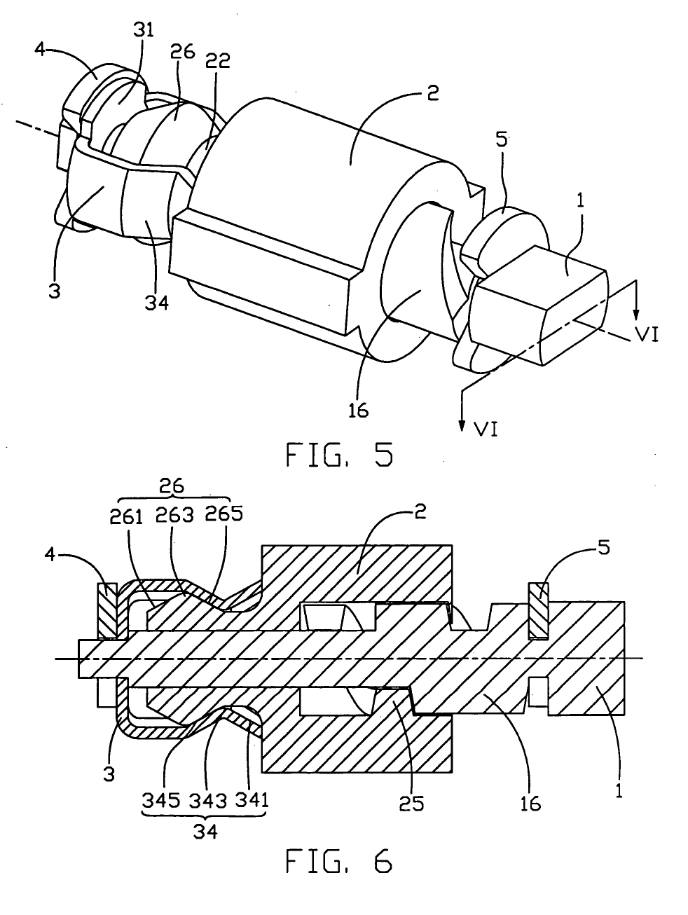

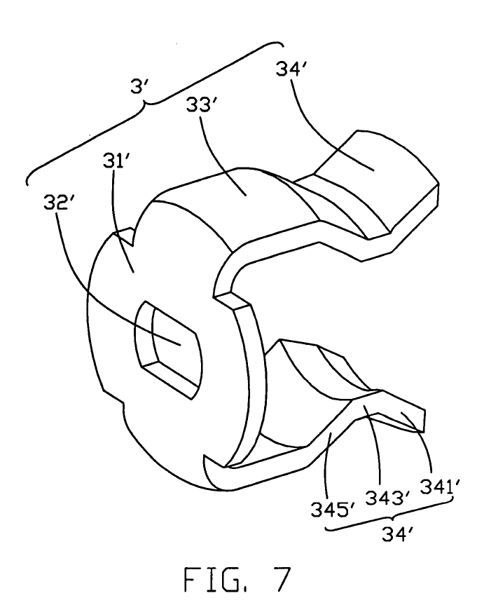

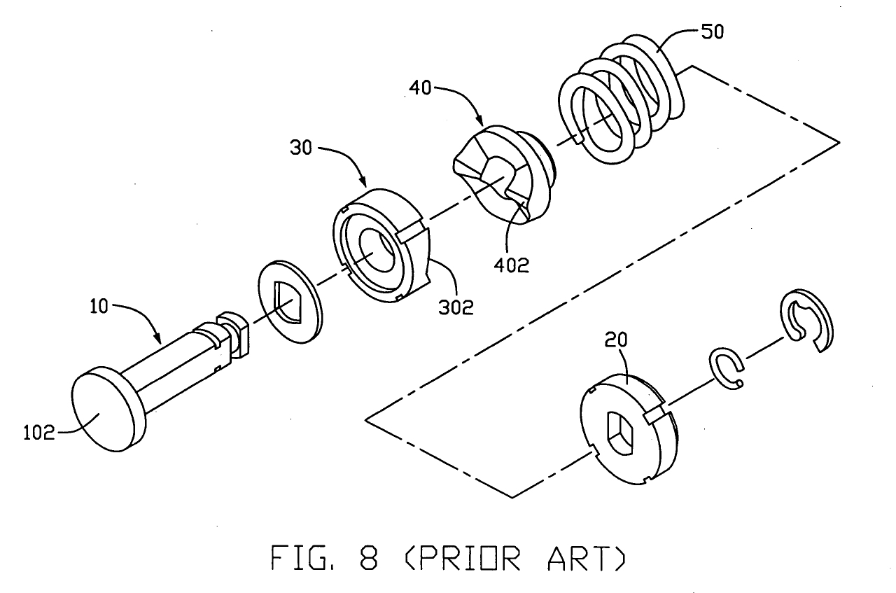

Referring to FIGS. 3-6, when the slopes 341 of the bent portions 34 of the locating member 3 abut against the slope 261 of the projection 26 of the second tubular portion 22, the cover of the foldable electronic device is held in a fully closed position. To open the foldable electronic device, the cover is manually rotated up from the body. Hence the cover drive member 2 is rotated about the body drive member 1. With the engagement of the outer screw thread 16 of the body drive member 1 and the inner screw thread 25 of the first tubular portion 21 of the cover drive member 2, the cover drive member 2 is thereby axially moved away from the disk 5. In this process, the slope 261 of the projection 26 rides along the slopes 341 of the bent portions 34, and the arms 33 of the locating member 3 are expanded radially outwardly. Once the ridge 263 of the projection 26 has ridden over the ridges 343 of the bent portions 34, the arms 33 rebound radially inwardly and drive the second tubular portion 22 to continue moving axially in the same direction, with the slope 265 of the projection 26 riding along the slopes 345 of the bent portions 34. Hence the cover drive member 2 continues to rotate in the opening direction. The cover is thus opened automatically to a fully open position at which the second tubular portion 22 is closely opposite to the base board 31 of the locating member 3, as shown in FIG. 5.

To close the foldable electronic device, the cover is manually rotated down toward the body. Hence the cover drive member 2 is rotated about the body drive member 1. With the engagement of the outer screw thread 16 and the inner screw thread 25, the cover drive member 2 is thereby axially moved away from the base board 31 of the locating member 3. As a result, the slope 265 rides along the slopes 345, and the arms 33 of the locating member 3 are expanded radially outwardly. Once the ridge 263 has ridden over the ridges 343, the arms 33 rebound radially inwardly and drive the second tubular portion 22 to continue moving axially in the same direction, with the slope 261 of the projection 26 riding along the slopes 341 of the bent portions 34. Hence the cover drive member 2 continues to rotate in the closing direction. The cover is thus closed automatically to the fully closed position at which the first tubular portion 21 abuts the disk 5, as shown in FIG. 3.

During the processes of the cover automatically opening or closing, the cover drive member 2 and hence the cover are subjected to the rebounding force produced by the expanded locating member 3. The slopes 261/265 of the projection 26 are in slidable contact with the corresponding slopes 341/345 of the bent portions 34, which produces an amount of friction between the cover drive member 2 and the locating member 3. This limits the speed of opening and closing of the cover, so that the cover is protected from damage.

Referring to FIG. 7, a locating member 3′ in accordance with an alternative embodiment of the present invention has a base board 31′. A hatch 32′ is defined in a center of the base board 31′. The base board 31′ is engaged with the body drive member 1 in the slots 13. A pair of symmetric arcuate arms 33′ extends perpendicularly from two opposite edges of the base board 31′ respectively. A distal end of each arm 33′ is bent radially inwardly to form a bent portion 34′. The bent portion 34′ has two slopes 341′, 345′ at opposite sides of a ridge 343′ respectively. The ridge 343′ has a flat surface. During rotation of the cover of the foldable electronic device, when the ridge 263 of the projection 26 reaches the ridges 343′ of the bent portions 34′, the flat surfaces of the ridges 343′ enable the projection 26 to remain stably in position. That is, the cover drive member 2 can remain stable relative to the locating member 3′ at any of a plurality of positions at which the ridge 263 is in contact with the ridges 343′. Accordingly, the cover drive member 2 can be stably held relative to the body drive member 1 at a plurality of positions. This means that the cover can be located to and automatically held at any of a plurality of partly open positions. Further or alternatively, in similar fashion, the ridge 263 of the projection 26 may have a flat surface.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hinge assembly for a foldable electronic device, comprising:
a body drive member having an outer screw thread;
a cover drive member having a projection formed on an outer periphery thereof, and defining a central hole, an inner screw thread being formed in the hole; and
a locating member having a base board, and at least one arm extending from one end of the base board, a distal end of said arm having a bent portion, and the base board defining a hatch;
wherein the body drive member extends through the hole of the cover drive member and the hatch of the locating member, thereby integrating the hinge assembly into a complete unit, with the outer screw thread of the body drive member engaging with the inner screw thread of the cover drive member, and the projection of the cover drive member abutting the bent portion of the locating member.

2. The hinge assembly as claimed in claim 1, wherein the body drive member is a shaft essentially in the form of a round rod.

3. The hinge assembly as claimed in claim 2, wherein a head is defined at a first end of the body drive member.

4. The hinge assembly as claimed in claim 3, wherein a lock member is formed at an opposite second end of the body drive member.

5. The hinge assembly as claimed in claim 4, wherein the lock member is substantially a regular block.

6. The hinge assembly as claimed in claim 3, wherein the body drive member defines at least one slot adjacent the head.

7. The hinge assembly as claimed in claim 6, further comprising a disk defining a notch.

8. The hinge assembly as claimed in claim 1, wherein the cover drive member comprises a first tubular portion and a second tubular portion, and the two tubular portions are coaxial with each other and commonly share the central hole.

9. The hinge assembly as claimed in claim 8, wherein at least one protrusion is provided on an outer periphery of the first tubular portion.

10. The hinge assembly as claimed in claim 8, wherein the inner screw thread is formed on an inside wall of the first tubular portion.

11. The hinge assembly as claimed in claim 8, wherein the projection is formed on a circumferential periphery of the second tubular portion.

12. The hinge assembly as claimed in claim 1, wherein a ridge of the bent portion of the locating member has a flat surface.

13. The hinge assembly as claimed in claim 1, wherein a ridge of the projection of the cover drive member has a flat surface.

14. A hinge assembly for rotary interconnection of components of an electronic device, comprising:
a first drive member attached to one of said components and moving together therewith;
a second drive member attached to another of said components and moving together therewith, and engagable with said first drive member to rotate relatively to said first drive member; and
a locating member fixed to one of said first and second drive members and having a frictional engagement with another of said first and second drive members to reduce rotary speed of said second drive member relative to said first drive member.

15. The hinge assembly as claimed in claim 14, wherein an outer screw thread is formed on said first drive member to engage with an inner screw thread of said second drive member so as to guide rotation of said second drive member relative to said first drive member.

16. The hinge assembly as claimed in claim 14, wherein said locating member has at least one resiliently metallic arm to frictionally engage with said another of said first and second drive members.

17. A hinge assembly for rotary interconnection of components of an electronic device, comprising:
a first drive member attached to one of said components and moving together therewith;
a second drive member attached to another of said components and moving together therewith, and engagable with said first drive member to rotate relatively to said first drive member; and
a resiliently metallic locating member disposed between said first and second drive members and having a frictional engagement with one of said first and second drive members to reduce rotary speed of said second drive member relative to said first drive member.
